(19) United States
(12) Patent Application Publication
(10) Pub. No.: US 2019/0104200 A1
(43) Pub. Date: Apr. 4, 2019

(54) Network Certification Augmentation and Scalable Task Decomposition

(71) Applicant: CA, Inc., New York, NY (US)

(72) Inventors: Yang Yang, Newton, MA (US); Li Tang, Lee, NH (US); Zubing Robin Qin, Southborough, MA (US)

(21) Appl. No.: 15/721,576

(22) Filed: Sep. 29, 2017

(51) Int. Cl. H04L 29/08; H04L 12/24; G06F 9/445

(52) U.S. Cl. CPC H04L 67/34; H04L 41/0843; H04L 41/0889; G06F 8/60; H04L 41/5054

(57) ABSTRACT

A certification-based network manager can consume either simple certifications or collection-inclusive certifications. For a simple certification, the certification-based network manager selects a discovery/collection template for the simple certification and associates the simple certification with at least some of the program code from the selected template. The program code from the selected template includes re-usable blocks or regions of program code (“task functions”) for device discovery and data collection. The certification-based network manager selects the template and the task functions based on the parameters and expressions of the simple certification, and associates with the simple certification to generate an augmented certification. The augmented certification can later be decomposed into individual tasks for scalable dispatch to data collectors.

### BACKGROUND

The disclosure generally relates to the field of data processing, and more particularly to network management data processing.

To monitor the health of devices in a network, a business uses a network monitoring/analysis tool that collects data from the devices. The collected data typically includes configuration data (e.g., number of ports, component identifiers, etc.) and performance data (e.g., interface throughput, processor utilization, etc.). The data collection is guided by a certification file (“certification”) for each different type of device in the network. The certification specifies the data to collect from the corresponding device. In the case of a network with simple network management protocol (SNMP) compliant devices, the certification will specify object identifiers (Ms) that define paths to particular data desired by the business for monitoring the health of devices throughout its network. The network monitoring tool includes program code to collect the data as specified by the OIDs in the certification.

Although data collection can be done according to the well-defined SNMP, not all devices support SNMP. In addition, a device may support SNMP for some but not all components and/or operational data of the device. This leads to certifications taking different forms, some of which are created based on greater experience and programming skills.

### BRIEF DESCRIPTION OF THE DRAWINGS

Embodiments of the disclosure may be better understood by referencing the accompanying drawings.

FIG. 1 is a conceptual diagram that illustrates an example certification-based network manager augmenting and parallelizing a simple certification.

FIG. 2 is a flowchart of example operations for augmenting a simple certification.

FIG. 3 is a flowchart of example operations for generating and distributing execution blocks from a certification retrieved from a certification repository.

FIG. 4 depicts an example computer system with a certification-based network manager that accepts both simple certifications and collection-inclusive certifications.

### DESCRIPTION

The description that follows includes example systems, methods, techniques, and program flows that embody embodiments of the disclosure. However, it is understood that this disclosure may be practiced without these specific details. For instance, this disclosure refers to extensible markup language (“XML”) in illustrative examples. Embodiments of this disclosure can be also applied to other formats such as JavaScript® object notation (“JSON”), comma-separated values (“CSV”), or custom data formats. In other instances, well-known instruction instances, protocols, structures, and techniques have not been shown in detail in order not to obfuscate the description.

Overview

Certifications can be simple certifications that are generated as files written in a standard data format and do not include specialized device discovery and data collection program code. These certifications are relatively easy to generate by inserting parameters into a file with either a structured data format (e.g., data tables) or semi-structured data format (e.g., XML or JSON). These certifications can also include expressions to calculate values based on some of these parameters. Because these certifications are generated according to a defined protocol (e.g., SNMP), they are often created without discovery/collection program code and rely on the collection program code available in a network monitoring tool that consumes the certification. However, some devices may not comply with a defined protocol or may include components that do not comply with a defined protocol. For these cases, “custom” certifications are created that include specific or custom collection program code.

Custom certifications are custom-made certifications that include program code to perform discovery/collection. These certifications (“collection-inclusive certifications”) can be written as executable scripts tailored for a device or set of devices. These collection-inclusive certifications include discovery/collection program code for a network monitoring tool to execute in order to discover devices and collect data. The network monitoring tool would execute the collection program code in the collection-inclusive certification because the device or set of devices at least do not have components that comply with a well-defined protocol relied upon by the collection program code of the network monitoring tool. For example, a device may be discoverable with SNMP commands and have a mixture of data items that can be collected according to SNMP and data items that cannot. A custom certification for this device would include custom collection program code to collect those data items managed by non-SNMP agents, whereas fixed discovery program code might only discover one of the data items or misclassify the data items as not belonging to the same device. Relative to simple certifications, however, these collection-inclusive certifications are complicated to generate. Moreover, these collection-inclusive certifications may not scale with a large number of devices during execution of the script in a production environment.

An application or tool that manages certification based device discovery and data collection for a network (“certification-based network manager”) is disclosed that can consume (i.e., accept as input) either simple certifications or collection-inclusive certifications. For a simple certification, the certification-based network manager selects a discovery/collection template for the simple certification and associates the simple certification with at least some of the program code from the selected template. The program code from the selected template includes re-usable blocks or regions of program code (“task functions”) that can be inserted into other program code, that can wrap around other program code, or that can be assembled into a file for execution. The task functions in the templates of the certification-based network manager can be executed to perform various tasks of device discovery and data collection. The certification-based network manager selects the template and the task functions based on the parameters and expressions of the simple certification.

Associating this template program code with the simple certification generates an augmented certification. To generate the augmented certification, the certification-based network manager inserts selected task functions from the template into a file, and creates a task chain that indicates an execution sequence for the task functions. The task chain also indicates which of the task functions can be used to generate execution blocks and manager blocks. A manager block can indicate how to parallelize execution blocks across data collectors, which increases scalability and efficiency. The certification-based network manager also increases the ease of use during certification development by allowing end-users to develop simple certifications instead of more complex collection-inclusive certifications regardless of the devices within the managed network. In addition, generating an augmented certification from a simple certification increases the flexibility of the network management system because the certification-based network manager accept different types of certifications (i.e., custom certifications and simple certifications that are the basis for augmented certifications).

### Example Illustrations

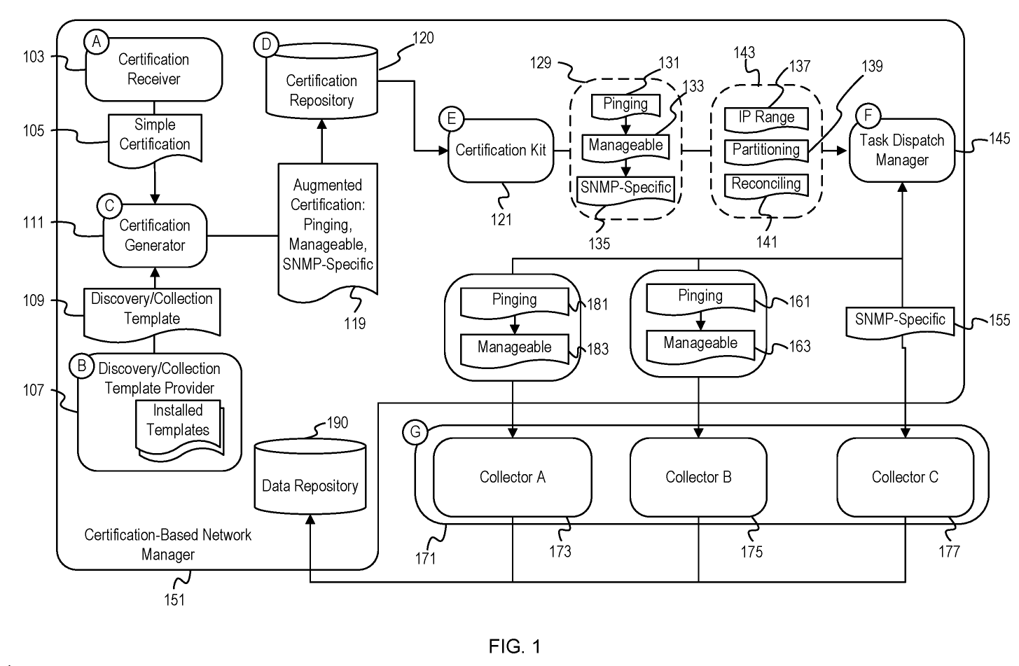

FIG. 1 is a conceptual diagram that illustrates an example certification-based network manager augmenting and parallelizing a simple certification. FIG. 1 depicts a certification-based network manager (“network manager”) 151. The network manager 151 includes a certification receiver 103, a discovery/collection template provider 107, a certification generator 111, a certification kit 121, a certification repository 120, a task dispatch manager 145, and a data repository 190. FIG. 1 also depicts a set of collectors 171 that execute execution blocks delegated to them by the network manager 151.

FIG. 1 is annotated with a series of letters A-G. These letters represent stages of one or more operations in each stage. Although these stages are ordered for this example, the stages illustrate one example to aid in understanding this disclosure and should not be used to limit the claims. Subject matter falling within the scope of the claims can vary with respect to the order and to some of the operations.

At stage A, the certificate receiver 103 receives a simple certification 105. The simple certification is a certification that includes device-specific attributes such as device metrics, metric calculations, and data models that are interpretable by a system using a standard network management protocol, such as SNMP. For example, the simple certification can be a SNMP certification written in XML. As an example, an SNMP-compliant format can be similar to the sample portion of an SNMP-compliant certification below:

<FacetType ... name = “CiscoCPUMibRev>
<AttributeGroup name=″cpmCPUTotalTable″>
<Attribute name=″ncpmCPUindex″ type=″ObjectID″>
<Source>1.3.6.1.4.1.9.9.109.1.1.1.1.8</Source>
</Attribute> defines collected metrics
<Attribute name=″cpmCPUTotal5min″ type=″Long″>
<IsKey>false</IsKey>
<Source>1.3. 6.1.4.1.9.9.109.1.1.1.1.5</Source>
</Attribute>
<Expressions>
<ExpressionGroup isA=”CPU>
<Expression metric=″Indexes″>cpmCPUindex</Expression>
<Expression metric=″Names″>″CPU ″ + cpmCPUIndex</Expression>
</ExpressionGroup>
</Expressions>

At stage B, the discovery/collection template provider 107 selects a discovery/collection template 109. The discovery/collection template provider 107 selects the discovery/collection template 109 from a set of installed discovery/collection templates. The discovery/collection template 109 includes task functions for device discovery and/or device data collection tasks. Examples of these tasks include pinging one or more internet protocol (“IP”) addresses, determining whether a device is manageable by the network manager 151, and determining what protocol(s) to use when interacting with a manageable device. In addition, task functions in the template 109 can be executed to perform more complex discovery and polling tasks (e.g., determining available ports if a device has multiple ports or application layers). The discovery/collection template 109 can also include a task chain (i.e., program code that defines a sequence for task functions). For example, the discovery/collection template 109 can include a first task function to ping each of a set of IP addresses, a second task function to determine which of the IP addresses are manageable devices and what protocol to use to communicate with the manageable devices, a third task function specific to SNMP-compliant devices (“SNMP-specific task function”), a fourth task function specific to secure file transfer protocol (SFTP)-compliant devices, a fifth task function to reconcile device data, and a task chain that specifies that the sequence for executing the five task functions. One form of this discovery/collection template can be as follows:

```
@Task
ping = {
  ip -> // input IP address
  def result = [ ];
  return result;
}
@Task
manageable = {
  ip -> // input IP address
  def result = [ ];
  return ( result, profile);
}
@Task
snmp = {
  ip, profile -> //input IP address
  def devices = [ ]
  // insert substitution stuff
  return default_snmp(ip, profile)
}
@Task
sftp = {
  ip, profile -> // input ip and profile
  def default_snmp = grab(.default_sftp.groovy)
  return default_snmp(ip, profile)
}
@Task
reconcile = {device -> // get devices discovered and reconcile with
existing devices}
@TaskChain
def tasks =
chain( ).input( “138.42.1-100.”).partition(4).dist(ping).dist(manageable)
.parolld( ).dist(snmp).dist(sftp).join( ).local(reconcile)
```

In the example task functions above, the parameter “ip” can be populated with an IP address and each program code section after the “@Task” field is a task function. Both the “sftp” and “snmp” assignments are protocol-specific task functions that can be replaced or augmented by the certification generator 111. The task chain defines an execution sequence of task functions “tasks” after the “@TaskChain” field with arguments populated for the task functions. In this illustration, the arguments include an input IP address range is “138.42.1-100” for discovery. The “dist( . . . )” function in the task chain specifies that the task function in the parentheses can be distributed.

Selection of the template for an input simple certification can be based on information within the simple certification or information encoded into a name of the simple certification. Selection of the template can also be based on a certification attribute such as a file type, file metadata, a value assigned to a context variable, etc. For example, the discovery/collection template provider 107 can select a discovery/collection template 109 that includes a SNMP-specific task function based on the certification file type being “.XML.” In addition, embodiments can select a template and then modify the selected template. For example, the discovery/collection template provider 107 can modify the discovery/collection template 109 based on a context variable. The discovery/collection template provider 107 can modify the discovery/collection template 109 to include program code to discover three data items based on a string value of an expression group name in the simple certification 105.

Alternatively, the discovery/collection template provider 107 can select the discovery/collection template 109 independent of any other parameters. For example, in the absence of any context variables or triggers, the discovery/collection template provider 107 selects a preset default discovery/collection template as the discovery/collection template 109.

At stage C, the certification generator 111 generates an augmented certification 119 based on the simple certification 105 and the discovery/collection template 109. The augmented certification 119 includes data corresponding with the device-specific values and expressions (i.e., parameters) from the simple certification 105. The augmented certification 119 also includes the selected task functions and the task chain from the discovery/collection template 109. For example, the augmented certification 119 includes a pinging task function to ping a set of IP addresses (“pinging task function”), a task function to check if the pinged devices are manageable (“manageable task function”), a task function specific to SNMP-compliant devices (“SNMP-specific task function”), and a task chain that specifies the order in which to perform the three task functions.

Various methods can be used to generate the augmented certification 119 based on the simple certification 105 and the discovery/collection template 109. For example, the certification generator 111 can first generate one or more intermediary code sections that includes the device-specific parameters from the simple certification 105. The certificate generator can incorporate the one or more intermediary code sections into the pre-existing discovery/collection template 109 in the protocol-specific task functions. The population of arguments into task functions with parameters from the simple certification can be guided by rules that map parameters from the simple certification into task functions and the task chain based on established naming conventions and/or protocols. For example, using the SNMP-compliant certification portion written in XML above, one such intermediary code section can be:

```
// snmp data collection
x =
  snmptable(address :
  device_ip, community: snmp_profile.getCommunity( ),
  oids: [
  cpmCPUindex: “1.3.6.1.4.1.9.9.109.1.1.1.1.8 long”,
  cpmCPUTotal5min: “1.3.6.1.4.1.9.9.109.1.1.1.1.5 long”
  ]
// metric calculations
p = withSnmptable(x.value){[Indexes: _index, Names: “CPU” +
_index]}
// component update
p.each {
updateComponent(device_id, it, “NormalizedCPUInfo”);
}
```

At stage D, the certification generator 111 stores the augmented certification 119 in the certification repository 120. The certification generator 111 can add metadata to the augmented certification 119, include a tag with the augmented certification 119, or otherwise indicate whether a certification is generated from the certification generator 111. Although FIG. 1 only depicts submission of a simple certification, a custom certification can be loaded into the certification repository 120. In that case, the custom certification can be associated with information (e.g., tag or metadata) that indicates the certification is a custom certification. When storing augmented certifications, the certification generator 111 can store them under the same node/folder, referenced as a set in a data table, or share a same tag. For example, the augmented certification 119 can be stored with similar certifications in a folder titled “HR network certification blocks.”

At stage E, a certification kit 121 processes the augmented certification 119. In the case that the data collection operation is being operated in a development environment, the certification kit 121 is a non-distributed software development kit (SDK) and directly executes the task functions from the augmented certification 119 according to the corresponding task chain. For example, the certification kit 121 can determine that the data collection operation is being operated in a development environment and sequentially execute a third task function, second task function, and then a first task function based on the corresponding task chain that specifies to operate the third task function, second task function and first task function in that order.

In the case that the data collection operation is being operated in a production environment, the certification kit 121 is a production SDK and uses the augmented certification 119 to generate a set of execution blocks 129. At least one of the set of execution blocks 129 is determined based on the task chain from the augmented certification 119. For example, a task chain can specify that a pinging task function, manageable task function, and SNMP-specific task function are to be executed in that order. Based on the task chain, the pinging, manageable, and SNMP-specific task functions are converted into a pinging execution block 131, manageable execution block 133, and SNMP-specific execution block 135, respectively. In other words, the network manager 151 uses the task functions to generate executable programs external to the augmented certification. During execution block generation, certification parameters can be incorporated as arguments of any relevant execution block (e.g. incorporating device-specific values into the SNMP-specific execution block 135).

In addition, the certificate kit 121 generates a set of manager blocks 143 in the production environment. The set of manager blocks 143 includes an IP range manager block 137, a partitioning manager block 139, and a reconciling manager block 141. The IP range manager block 137 specifies a range of IP addresses for pinging. The IP range manager block 137 can be based on a user-defined range, determined based on a context variable, etc. For example, the IP range manager block 137 can provide instructions to ping all IP addresses that match the pattern “1.3.2*” based on a context variable providing an IP address segment “1.3.2.” The partitioning manager block 139 specifies the number of collectors to receive and execute the execution blocks. The partitioning manager block 139 can partition execution blocks across different collectors dynamically (e.g., based on a number of available collectors). For example, the partitioning manager block 139 can determine that five collectors are available and specify how to partition the manager blocks equally amongst the five collectors. The reconciling manager block 141 reconciles data transmitted from the collectors and data stored in the network manager 151. Reconciliation can be based on heuristics and/or an algorithmic determination of reconciliation. For example, a set of heuristics or a reconciliation algorithm can indicate that two sets of data are for the same device if they share at least four out of six metric calculations, and that the two sets of data are not for the same device otherwise.

At stage F, a task dispatch manager 145 dispatches the set of execution blocks 129 to the set of collectors 171 according to the set of manager blocks 143. The collectors in the set of collectors 171 can be threads or processes in communication with the network manager to execute the execution blocks. Alternatively, the collectors can be instances of the execution blocks that include additional program code to communicate the collected data items to the network manager or data repository.

The operations represented at stages E and F begin based on detection of a trigger. The trigger can be activated as part of a regularly scheduled network service. For example, a network service can specify that the network manager 151 re-distributes copies of the set of execution blocks 129 every fifteen minutes, which would cause the task dispatch manager 145 to dispatch the execution blocks 129 accordingly. In other embodiments, the trigger can be set as a response to an event observed by the network manager 151. For example, the network manager 151 can detect that a new certification has been stored into the certification repository 120 and then cause the task dispatch manager 145 to dispatch the execution blocs 129. The task dispatch manager 145 can dispatch execution blocks to the collectors 171 using various strategies (e.g., a round robin selection strategy, a sticky selection strategy, a least-loaded system selection strategy, etc.). For example, the task dispatch manager 145 can use a least-loaded selection strategy to determine that collector A 173 and collector B 175 are the least loaded collectors of the collectors 171, and assign execution blocks to these collectors. Although the task dispatch manager 145 can dispatch tasks according to the previously mentioned selection strategies, the task dispatch manager 145 distributes the set of execution blocks 129 based on the partitioning manager block 139. The task dispatch manager 145 distributes execution blocks to a number of IP address sets in the IP address range specified by the IP range execution block 137.

The number of IP address sets is specified by the partitioning manager block 139. In this illustration, the partitioning manager block 139 specified that there would be two IP address sets for the pinging execution block 131 and the manageable execution block 133. The task dispatch manager 145 distributes an instance 181 of the pinging execution block 131 and an instance 183 of the manageable execution block 133 for a first IP address set to collector A 173. The task dispatch manager 145 also distributes an instance 161 of the pinging execution block 131 and instance 163 of the manageable execution block 133 for a second IP address set to collector B 175. The task dispatch manager 145 dispatches an instance 155 of the SNMP-specific execution block 135 to the collector C 177 for all devices determined to be SNMP-manageable by collector A 173 and collector B 175.

At stage G, the set of collectors 171 performs network management operations based on the set of execution blocks sent by the task dispatch manager 145 and transmits collected data to the data repository 190. The set of collectors 171 pings a subset of IP addresses, determines which of the set of responding IP addresses are manageable devices, determines what protocols are applicable to each of the manageable devices, and performs protocol-specific operations. Between each phase of a data collection operation, the network manager 151 can perform a load balancing operation to encourage more efficient distributions of execution blocks among the collectors. For example, collector A 173, collector B 175, and collector C 177 can ping a total of 10,000 IP addresses and determine that only 99 IP addresses have responded. In response, the network manager can perform a load-balancing operation to such that each of the collectors execute 33 manageable execution blocks. In some cases, each of the set of collectors 171 can store the execution blocks into their local data repository or cache, and regularly collect data based on the execution blocks.

The set of collectors 171 also updates the data repository 190 (directly or via the network manager 151) to reconcile potentially duplicate data based on the reconciling manager block 141. For example, both the collector A 173 and a certification data entry in the data repository 190 could have identical metric values for at least five metrics. Based on a reconciliation algorithm that determines that two sets of measurements are for the same device when at least five of the metric values are equal to each other, the two devices can be reconciled to be a single device when updating the data repository 190.

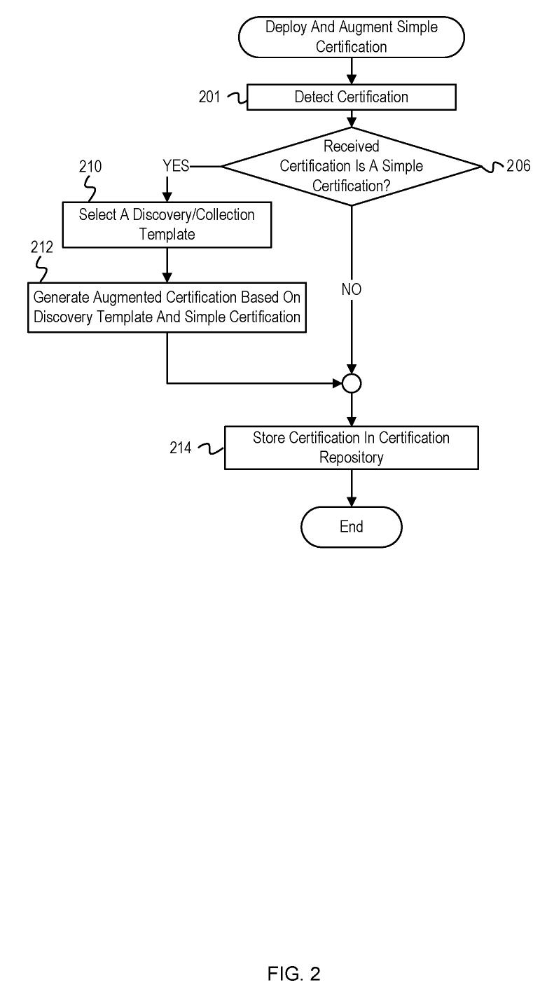

FIG. 2 is a flowchart of example operations for augmenting a simple certification. As previously stated, simple certifications can be used to generate augmented certifications to increase system flexibility. The augmented certifications can be used to generate execution blocks that can be distributed to further increase system operation speed and scalability. The flowcharts will refer to a network manager as performing the operations for consistency with FIG. 1.

A network manager detects a certification submitted for processing by the network manager (201). The network manager can monitor a database or memory location for newly loaded or submitted certifications. Certifications can be defined and submitted via an interface that causes a notification to be generated for the network manager.

Based on detection of the certification, the network manager determines whether the detected certification is a simple certification (206). The network manager can determine that the initial certification is a simple certification if the certification file type is a known simple certification file type (e.g., XML or JSON). The network manager can inspect the contents of the certification to determine whether the certification contents are limited to parameters or metric expressions based on format of the content. In other words, the network manager can inspect the contents of the detected certification to determine whether it includes executable or interpretable program code (i.e., function/method definitions) and therefore is not recognized as a simple certification. If the network manager determines that the detected certification is a simple certification, then the network manager proceeds to select a discovery/collection template based on the detected certification (210). A network manager can select a discovery/collection template from multiple installed discovery/collection templates based on a context variable or a value from the simple certification. For example, a network manager can select a discovery/collection template that either includes or does not include a task function specific to SFTP-compliant devices (“SFTP-specific task function”) based on whether a data model name from a simple certification includes a term associated with SFTP-compliant devices. Selection of the template can also be based on a certification attribute such as a file type, file metadata, a value assigned to a context variable, etc. For example, the discovery/collection template provider can select a discovery/collection template that includes program code to attempt discovery of five data items for devices for a specific IP address range and only one data item for devices outside of the specific IP address range based on a context variable specifying the specific IP address range. The network manager can also modify a selected discovery/collection template. For example, the network manager can select a discovery/collection template that include a SFTP-specific task function and remove the task function based on a data model name from a simple certification that does include any terms associated with SFTP-compliant devices.

After selection of the discovery/collection template (210), the network manager generates an augmented certification based on the discovery/collection template and the simple certification (212). The network manager can generate the augmented certification by inserting parameters from the simple certification into corresponding ones of the task functions in the discovery/collection template to form an augmented certification. For example, the network manager can generate an intermediary SNMP-specific task function based on inserting the parameters from the simple certification into the SNMP-specific task function of the discovery/collection template. The determination of correspondence can be based on cues within the task functions and/or the template (e.g., formatting requirements and/or naming conventions expected of parameters to be inserted into the task functions). The augmented certification is written in programming code that can be interpreted by the network manager, and includes a task chain from the discovery/collection template, as well as the task functions of the template with parameters inserted from the simple certification.

After generation of the augmented certification (212) or if the detected certification is not a simple certification (206), the network manager stores the augmented certification into the certification repository (214). The certification repository can store augmented certifications as well as custom certifications that are directly deployed into the certification repository. The network manager can add metadata or tags to specify that a certification can be used to generate execution blocks.

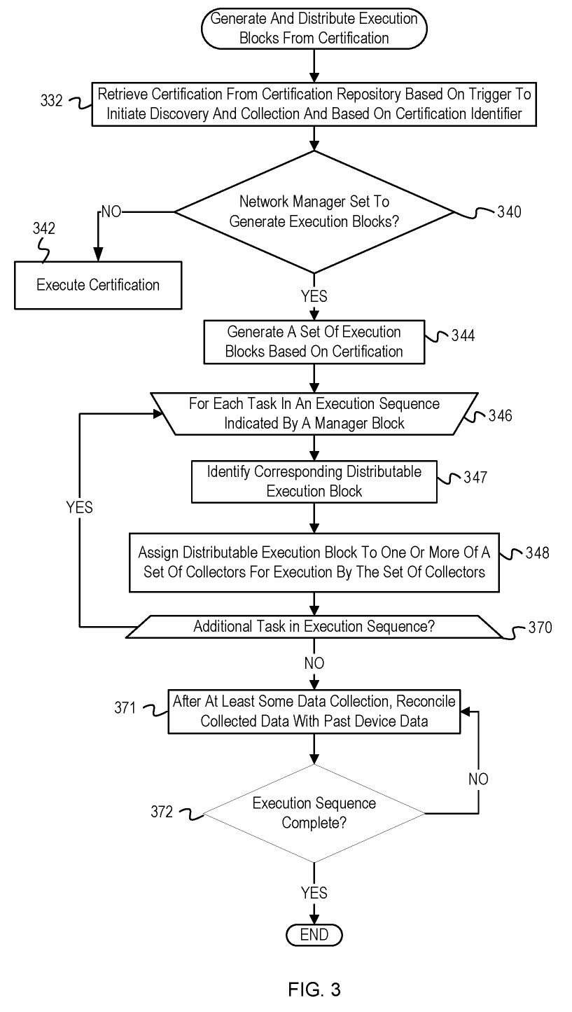

FIG. 3 is a flowchart of example operations for generating and distributing execution blocks from a certification retrieved from a certification repository. Once a certification is available in the certification repository, the network manager can detect a discovery/collection trigger (e.g., manual user command or system event) and, in response, can retrieve a stored certification to perform device discovery and data collection operations based on the certification (332). The trigger can be generated based on the network manager detecting a discrete event, such as storing of a new certification or expiration of a time period between discoveries and/or collections. The network manager can determine which of the certifications to retrieve based on the trigger. As examples, a command can specify which certification to retrieve from the repository; the most recent certification can be retrieved from the repository; and a certification can be retrieved based on a domain or network identifier to be monitored. The network manager searches the certification repository based on a certification identifier indicated by the trigger. The search mechanism may search object/file metadata for the source certification identifier.

The network manager determines whether it is to generate a set of execution blocks and manager blocks based on the retrieved certification (340). In some cases, this determination can be made based on a user selection. In other cases, a network manager can determine that it is to generate execution blocks if the data collection operation is being performed in a production environment and the certification is an augmented certification. If the network manager is not to generate a set of execution blocks, then the network manager executes the program code of the certification returned by the searching or retrieves the certification indicated in the search result and then executes the retrieved certification (342). The network manager can either directly execute the collection-inclusive certification or transmit the collection-inclusive certification to a collector for execution.

If the network manager is to generate execution blocks, the network manager can generate a set of execution blocks based on the certification (344). The network manager can parse task functions from the augmented certification based on the task chain from the augmented certification. The network manager can then generate execution blocks that correspond with the parsed task functions such that the execution blocks can provide the same results as their respective task functions. These execution blocks are distributable to collectors by the network manager. For example, execution blocks can include execution blocks to ping an IP address, determine if a data item can be managed, and perform protocol-specific operations. The task chain can include functions or indicators that indicate which task functions to use for execution block generation based on the task chain. For example, the network manager can generate execution blocks for each of the task functions that are surrounded by the “dist( . . . )” function in the task chain. Alternatively, the network manager can generate one or more execution blocks based on tags, certification metadata, or a map of the certification. For example, the network manager can generate an execution block for each task function mapped to a key titled “distributable” in a map from the certification.

The network manager can also generate manager blocks that can be directly executed by the network manager. The network manager can use the manager blocks to determine network-level activity such as what range of IP addresses to ping, how many collectors will be used, and how collected data will be reconciled with any existing device stored in the data repository. The network manager can generate manager blocks based on the task chain. For example, the network manager can generate a manager block for each of the task functions that are not surrounded by the “dist( . . . )” function in the task chain. Other embodiments can generate manager blocks for the task functions from the certification that were not used to generate an execution block. Alternatively, the network manager can generate one or more manager blocks based on tags, certification metadata, or a map of the certification. For example, the network manager can generate a manager block for each task function specified in a list titled “For Manager Block Certification” in metadata from the certification.

The network manager distinguishes the execution blocks from the manager blocks that guide assignment or delegation of the execution blocks when a corresponding certification is to be performed. The network manager can distinguish the different types of blocks by organization (e.g., different sub-folders or sub-directories), naming convention, metadata in file headers, etc. A network manager can also generate a set of execution blocks and manager blocks based on a collection-inclusive certification. The network manager can specify formatting and organization of collection-inclusive certifications to guide the network manager in parsing the certification. The network manager can evaluate a collection-inclusive certification to determine whether it is structured according to the specification and/or read certification metadata that indicates whether the certification complies with the specification that facilitates parsing.

In some embodiments, the network manager can store the execution blocks in the certification repository after the set execution blocks are generated. The network manager can store the execution blocks with an indication of the augmented certification and/or simple certification that is a source for the execution blocks. This can be done according to different techniques or a combination of techniques. For instance, the execution blocks can be organized into a folder or directory that indicates the source certification (e.g., the name of the source certification file). The network manager can identify the source certification in the names or in metadata of each of the execution blocks. The network manager can store the source certification in the certification repository along with the execution blocks.

Once the execution blocks are generated, the network manager determines how to manage execution of the execution blocks based on an execution sequence indicated in a manager block (346). For each task in the execution sequence, the network manager identifies a corresponding one of the generated execution blocks (347). The network manager can identify the corresponding one of the execution blocks based on at least a partial match between the task identifier and execution block identifiers. Embodiments can also persist the task names from the source certification into the execution blocks, for example as file metadata, and use the persisted identifiers to identify corresponding execution blocks.

The network manager assigns the identified execution block to one or more of a set of collectors (348). The network manager determines whether to assign the execution block to one of the collectors or to distribute the execution block to multiple of the set of collections (and how to distribute) based on the manager blocks, examples of which include IP range manager blocks and partitioning manager blocks. For example, when the IP range execution block provides a set of 100 unique IP addresses, the partitioning manager block can establish that two collectors determine the manageability of the 100 unique IP addresses (e.g., determining whether each of the device corresponding with the IP addresses is manageable and/or what protocol to use when communicating with the device). The network manager can then divide the 100 unique IP addresses in various ways, such as by assigning the first 50 IP addresses to a first collector and then assigning the second 50 IP addresses to the second collector. The partitioning manager block can also establish that a single collector performs SFTP-related execution blocks on each of the devices determined to be manageable using SFTP. The partitioning manager block can also establish that a single collector performs SNMP-related execution blocks on each of the devices manageable using SNMP. Based on this information from the partitioning manager block, the network manager assigns a third collector and fourth collector to perform the SFTP-related execution blocks and SNMP-related execution blocks, respectively. Based on assignment by the network manager, the collectors execute the assigned execution blocks. Based on the manager blocks, the network manager may assign a same execution block to different collectors for the same or different sets of devices. If there are additional tasks to assign in the execution sequence (370), then the network manager proceeds to the next task in the execution sequence. The network manager can impose a synchronization operation across collectors for an assignment of execution blocks to adhere to the execution sequence. For example, the network manager can execute one or more synchronization operations to allow each pinging execution block to finish executing before allowing any protocol-specific execution block to begin executing.

In some embodiments, a collector can store the execution blocks and/or manager blocks in their own collector certification repository or local cache. The collector certification repository or local cache can index execution blocks and manager blocks by a source certification identifier when initially stored in the collector certification repository or local cache. During a data collection (e.g., polling) event, a collector can execute the execution blocks stored in their collector certification repository or local cache and transmit collected data back to the network manager.

After at least some data item collection, the collectors transmit collected data items to a data repository. The example operations in FIG. 3 presume that the network manager will finish processing the task execution sequence in one of the manager blocks prior to return of date items by the collectors (370). However, collectors can begin returning data items to the data repository while the network manager is still processing the task execution sequence. During or after transmitting the data from the collectors to the data repository, the network manager reconciles the collected data with past device data (371). Data reconciliation allows device data to be correctly updated in the data repository and can be based on reconciliation algorithms. One example reconciliation algorithm is to establish that a pair of data sets are for the same device when they share the same IP address and share the same values for at least four metrics. While the execution blocks continue being executed according to the execution sequence by the collectors as assigned by the network manager, reconciliation likely completes proximate with completion of the execution sequence (372).

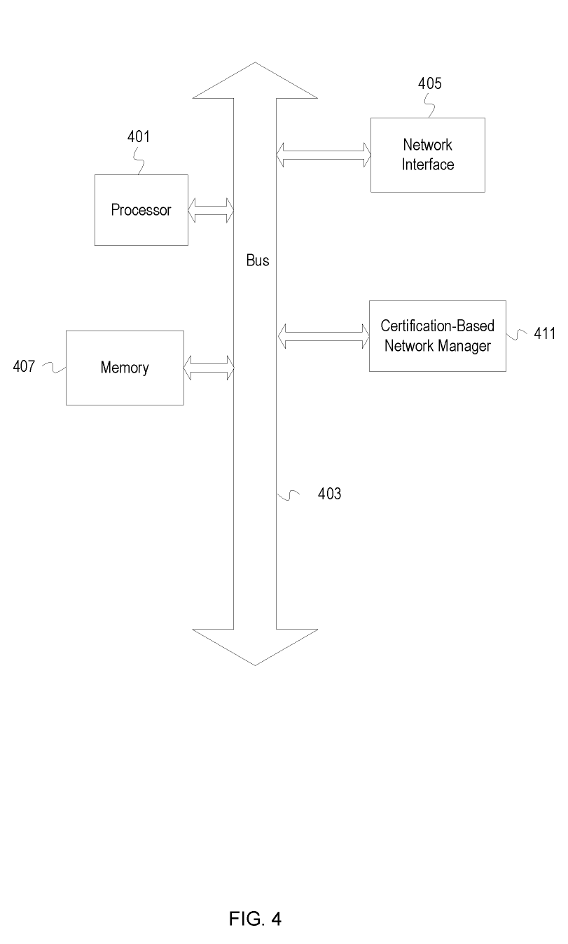

FIG. 4 depicts an example computer system with a certification-based network manager. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes a certification-based network manager 411. The certification-based network manager 411 generates an augmented certification based on a simple certification. The certification-based network manager 411 generates and distributes execution blocks derived from an augmented certification or a collection-inclusive certification to data collectors. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for a universal network manager than can process different types of certifications and decompose certifications into individual tasks that facilitates scalability of certification as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
detecting a first certification file for data collection from a plurality of network devices, wherein the first certification file comprises parameters for network device discovery and parameters for data item collection from discovered network devices;
determining that the first certification file lacks program code to perform network device discovery and data item collection from discovered network devices; and
based on the determination that the first certification file lacks program code to perform network device discovery and data item collection from discovered network devices, generating a second certification file based on the first certification file and a template file, wherein generating the second certification file comprises,
populating a plurality of re-usable code sections from the template file with the parameters from the first certification file as arguments; and
populating a task chain based, at least in part, on the parameters from the first certification file, wherein the task chain indicates a sequence for executing the plurality of re-usable code sections.

2. The method of claim 1 further comprising:
based on detection of a trigger that indicates the identifier of the first certification file,
generating an execution block from each of the plurality of re-usable code sections in the second certification file, wherein the execution block is a block of program code that can be executed independent of a source certification file;
generating a set of one or more manager blocks based on the task chain in the second certification file, wherein a manager block comprises information for managing execution of the execution blocks across a plurality of data collectors according to the sequence indicated in the task chain.

3. The method of claim 2 further comprising associating an identifier of the first certification file with the second certification file and storing the second certification file a repository based, at least in part, on the association with the identifier of the first certification file.

4. The method of claim 3 further comprising:
searching the repository with the identifier, based on the detection of the trigger;
wherein generating the execution blocks and the set of one or more manager blocks from the second certification file is based on retrieving the second certification file from the repository based on the searching; and
assigning the execution blocks to the plurality of data collectors based, at least in part, on the set of one or more manager blocks.

5. The method of claim 4, wherein assigning the execution blocks based, at least in part, on the set of one or more manager blocks comprises:
determining multiple ranges of network addresses indicated in a first manager block of the set of one or more manager blocks; and
assigning a first execution block of the execution blocks to at least a first data collector and a second data collector of the plurality of data collectors based, at least in part, on the multiple ranges of network addresses,
wherein assigning the first execution block to the first data collector comprises indicating a first of the multiple ranges of network addresses for the first data collector to target when executing the first execution block,
wherein assigning the first execution block to the second data collector comprises indicating a second of the multiple ranges of network addresses for the second data collector to target when executing the first execution block.

6. The method of claim 4, wherein assigning the execution blocks to the plurality of data collectors comprises assigning the execution blocks for execution in an order according to a sequence indicated in a first manager block of the set of one or more manager blocks.

7. The method of claim 4, wherein assigning the execution blocks to the plurality of data collectors comprises assigning execution blocks corresponding to different protocols to different ones of the plurality of data collectors.

8. The method of claim 4, wherein assigning the execution blocks comprises:
assigning a first execution block of the execution blocks to a first data collector of the plurality of data collectors; and
assigning a second of the execution blocks to multiple of the plurality of data collectors based, at least in part, on a first manager block of the set of one or more manager blocks and a result of the first data collector executing the first execution block.

9. The method of claim 1 further comprising selecting the template file from a plurality of template files based, at least in part, on an attribute of the first certification file.

10. The method of claim 1, wherein determining that the first certification file lacks program code to perform device discovery and data collection from discovered network devices comprises at least one of determining that the first certification file is of a file type indicated as not having the program code and inspecting the first certification file for content structured as program code to perform network device discovery and data item collection from discovered network devices.

11. One or more non-transitory machine-readable media comprising program code for generating blocks from source certification files for scalability and flexibility of the source certification files, the program code comprising instructions to:
detect a source certification file for data collection from a plurality of network devices, wherein the source certification file comprises parameters for network device discovery and parameters for data item collection from discovered network devices;
determine whether the source certification file lacks program code to perform network device discovery and data item collection from discovered network devices; and
based on a determination that the source certification file lacks program code to perform network device discovery and data item collection from discovered network devices, generate a plurality of execution blocks and a set of one or more manager blocks based on the source certification file and a template file that includes a plurality of re-usable code sections for discovery and data item collection, wherein the instructions to generate the plurality of execution blocks and the set of one or more manager blocks comprise instructions to,
generate the plurality of execution blocks based on the plurality of re-usable code sections from the template file and the parameters from the source certification file as arguments, wherein each of the plurality of execution blocks is executable separately from the template file and the source certification file;
generate the set of one or more manager blocks based, at least in part, on a task chain in the template file and at least one of the parameters from the source certification file, wherein the task chain indicates a sequence for executing the plurality of re-usable code sections.

12. The one or more non-transitory machine-readable media of claim 11, wherein the program code further comprises instructions to:
generate an intermediate certification file with the plurality of re-usable code sections having arguments populated from the parameters of the source certification file and with the task chain,
wherein the instructions to generate the plurality of execution blocks and to generate the set of one or more manager blocks comprise instructions to generate the plurality of execution blocks and to generate the set of one or more manager blocks from the intermediate certification file.

13. The one or more non-transitory machine-readable media of claim 11, wherein the program code further comprises instructions to select the template file from a plurality of template files based, at least in part, on an attribute of the source certification file.

14. An apparatus comprising:
a processor;
a network interface; and
a machine-readable medium comprising instructions executable by the processor to cause the apparatus to,
detect a source certification file for data collection from a plurality of network devices, wherein the source certification file comprises parameters for network device discovery and parameters for data item collection from discovered network devices;
determine whether the source certification file lacks program code to perform network device discovery and data item collection from discovered network devices; and
based on a determination that the source certification file lacks program code to perform network device discovery and data item collection from discovered network devices, generate a plurality of execution blocks and a set of one or more manager blocks based on the source certification file and a template file that includes a plurality of re-usable code sections for discovery and data item collection, wherein the instructions to generate the plurality of execution blocks and the set of one or more manager blocks comprise instructions to,
generate the plurality of execution blocks based on the plurality of re-usable code sections from the template file and the parameters from the source certification file as arguments, wherein each of the plurality of execution blocks is executable separately from the template file and the source certification file;
generate the set of one or more manager blocks based, at least in part, on a task chain in the template file and at least one of the parameters from the source certification file, wherein the task chain indicates a sequence for executing the plurality of re-usable code sections.

15. The apparatus of claim 14, wherein the machine-readable medium further comprises instructions executable by the processor to cause the apparatus to:
generate an intermediate certification file with the plurality of re-usable code sections having arguments populated from the parameters of the source certification file and with the task chain,
wherein the instructions to generate the plurality of execution blocks and to generate the set of one or more manager blocks comprise instructions executable by the processor to cause the apparatus to generate the plurality of execution blocks and to generate the set of one or more manager blocks from the intermediate certification file.

16. The apparatus of claim 14, wherein the machine-readable medium further comprises instructions executable by the processor to cause the apparatus to select the template file from a plurality of template files based, at least in part, on an attribute of the source certification file.

17. The apparatus of claim 14, wherein the instructions to generate the set of one or more manager blocks comprise instructions executable by the processor to cause the apparatus to generate at least a first manager block of the set of one or more manager blocks based, at least in part, on a first re-usable code section of the plurality of re-usable code sections, wherein the first re-usable code section comprises program code indicating how to assign at least one of the execution blocks across a plurality of data collectors.

18. The apparatus of claim 14, wherein the machine-readable medium further comprises instructions executable by the processor to cause the apparatus to associate an identifier of the source certification file with the plurality of execution blocks and the set of one or more manager blocks and to store the plurality of execution blocks and the set of one or more manager blocks in a repository based, at least in part, on the association with the identifier of the source certification file.

19. The apparatus of claim 18, wherein the machine-readable medium further comprises instructions executable by the processor to cause the apparatus to:
based on detection of a trigger that indicates the identifier of the source certification file, search the repository with the identifier; and
based on a result of the searching indicating the plurality of execution blocks and the set of one or more manager blocks previously generated from the source certification file, obtain the plurality of execution blocks and the set of one or more manager blocks;
assign the plurality of execution blocks to a plurality of data collectors based, at least in part, on the set of one or more manager blocks.

20. The apparatus of claim 18, wherein the machine-readable medium further comprises instructions executable by the processor to cause the apparatus to assign execution blocks corresponding to different protocols to different ones of a plurality of data collectors.
